(19) United States
(12) Patent Application Publication
(10) Pub. No.: US 2009/0286194 A1
(43) Pub. Date: Nov. 19, 2009

(54) TOOL FOR USE WITH A TOOTH REPOSITIONING MECHANISM

(76) Inventors: Kambiz Kohani, Carlsbad, CA (US); Don Millerd, San Diego, CA (US)

Correspondence Address: NYDEGGER & ASSOCIATES, 348 OLIVE STREET, SAN DIEGO, CA, 92103, US

(21) Appl. No.: 12/119,933

(22) Filed: May 13, 2008

(51) Int. Cl. A61C 7/00; A61C 7/02

(52) U.S. Cl. 433/3; 433/24

(57) ABSTRACT

A tool for rotating a component on a mechanism, to achieve linear and rotational movement of an element on the mechanism, involves three subassemblies mounted on the tool. Firstly, a reference unit that can engage with the mechanism to establish a stationary datum. Secondly, a drive assembly that can be rotated relative to the datum. Thirdly, an engagement member, selectively engaged between the component and the drive assembly for rotation of the component.

### FIELD OF THE INVENTION

The present invention pertains generally to adjusting tools. More particularly, the present invention pertains to tools that can be configured to cause a predetermined movement of a work object. The present invention is particularly, but not exclusively, useful as a tool for repositioning teeth in a dentition for subsequent use in the manufacture of a dental appliance.

### BACKGROUND OF THE INVENTION

In general, orthodontia is the branch of dentistry that is concerned with correcting and preventing irregularities of the teeth. In each case, the purpose is to have the upper and lower teeth meet with their respective cusps fitting close together. Stated differently, orthodontia involves the straightening of teeth in a dentition. As is well known, this process has heretofore most often required the use of wire braces. More recently, however, new systems for aligning teeth have been proposed. For example, U.S. patent application Ser. No. 11/230,323 for an invention entitled “Method and Apparatus for Repositioning Teeth”, which was filed by Kohani on Sep. 19, 2005, and assigned to the same assignee as the present invention (hereinafter the Kohani Application), discloses an orthodontic system in which a number of appliances are manufactured for sequential use. Importantly, successive appliances are manufactured with each one having a different predetermined configuration that will gradually reposition teeth of the dentition.

To manufacture a series of orthodontic appliances, as suggested above, it is necessary to successively reposition several, or all, teeth in a dentition. In this endeavor, each tooth in the dentition needs to be considered for each appliance, and repositioned accordingly. In any event, the repositioning of each tooth must be done in accordance with a procedure that is prescribed by a trained orthodontist, and it must be done subject to his/her supervision. Despite the high level of knowledge and oversight that is required from the orthodontist, the actual manufacture of an orthodontic appliance is straight forward and, with proper instructions, can be accomplished by a trained laboratory technician. This, of course, requires the instructions be easily understood and the proper tool be provided for following the instructions.

For the vast majority of orthodontic procedures, at least one tooth in the dentition needs to be moved fore or aft, left or right (i.e. in orthogonal directions) and/or rotationally about an axis defined by the tooth for each appliance in the series. Typically, the magnitude of tooth movements that are required between successive appliances will be small (e.g. <1 mm or <1°). Further, each tooth movement must have a known start point (i.e. the tooth location in the immediately preceding appliance). The Kohani Application recognizes these requirements and specifically provides for a model dentition in which individual teeth can be moved by external manipulation.

In light of the above, it is an object of the present invention to provide a system for manufacturing a dental appliance wherein each prosthetic tooth in a model dentition can be individually repositioned without requiring the taking of a new impression each time the dentition is to be corrected. Another object of the present invention is to provide a tool for manufacturing a dental appliance wherein a simple rotation of the tool through an angle “θ” will result in a desired linear or rotational movement of a prosthetic tooth in a model dentition. Still another object of the present invention is to provide a system for manufacturing a dental appliance which is simple to use, relatively easy to manufacture and comparatively cost effective.

### SUMMARY OF THE INVENTION

In accordance with the present invention, a tool is provided for rotating an adjustment component (e.g. a lead screw or a pinion) through a predetermined angle (θ). As intended for the present invention, this rotational movement results in the linear movement of a positioning element on an adjustment mechanism. The purpose here is to reposition a prosthetic tooth that is mounted on the element for subsequent use in the manufacture of a dental appliance.

As envisioned for the present invention, the mechanism has two interactive elements that move in orthogonal directions. In this combination, each element is moved independently by its own adjustment component. For example, one component may be a rack and pinion type device, and the other may be a lead screw type device. Thus, in response to the rotation of a lead screw (or pinion), one orthogonal element of the mechanism will move the prosthetic tooth in an x-direction. A rotation of the pinion (or lead screw) of the other orthogonal element will then move it in a y-direction. These independent linear movements in the ‘x’ and ‘y’ directions are accomplished separately by directly engaging the tool with the respective adjustment component (pinion or lead screw).

Mechanically, the rotation of the pinion (lead screw) through an angle “θ”, will result in a linear movement of the prosthetic tooth through a distance “d”. As mentioned above, depending on the element that is rotated, movement of the tooth may be in either the x-direction or the y-direction. In either case, the mathematical relationship is represented by the expression: “rθ=d”; wherein “r” is the radius of the rotated component (pinion or lead screw) measured in radians. As envisioned for the present invention, the desired tooth movement, “d”, is clinically predetermined. The angle of rotation “θ” required to achieve this movement can then be quantified by the mathematical expression.

As envisioned for the present invention, the mechanism has an interactive element that provides for rotation of the tooth about the tooth's axis. Similar to the orthogonal elements, the rotation element is moved independently by its own adjustment component. For example, the rotational component may include a rotation arm (similar to a pinion) that is provided with a translating joint for connection to the rotation element. Thus, in response to the rotation of the rotation arm, the element of the mechanism will rotate the prosthetic tooth about its axis. This independent rotational movement about the tooth's axis is accomplished separately from the orthogonal movements by directly engaging the tool with the rotational adjustment component. Mechanically, the rotation of the arm through an angle “θ”, will result in a rotational movement of the prosthetic tooth through the same angle “θ”.

For the present invention, the tool defines an axis, and it has essentially three interactive sub-assemblies. These are: a reference unit, a drive assembly and an engagement member. Functionally, the reference unit of the tool is engaged with the adjustment mechanism to thereby establish a stationary datum. The drive assembly, which is attached to the reference unit, can then be positioned relative to the reference unit as desired (e.g. positioned to establish the predetermined angle “θ”). Once the datum is established and the drive assembly has been properly positioned relative thereto, the engagement member is used to interconnect the drive assembly with the adjustment component that is to be rotated (pinion or lead screw). The drive assembly can then rotate the engagement member, together with the adjustment component (pinion or lead screw). This rotation continues, until the adjustment component has been rotated through the predetermined angle (θ).

For rotational control, the tool includes a dial that is located at its proximal end. In detail, this dial identifies a fixed reference line and it has a moveable indicator. Specifically, when viewed together, the reference line and the indicator identify the angular relationship between the reference unit and the drive assembly. Importantly, the reference line and the indicator on the dial are, respectively, integral parts of the reference assembly and the drive assembly.

Structurally, the drive assembly includes a base member. And, as implied above, the indicator on the dial is integrally connected to this base member. Further, the base member is formed with a tapered probe at its distal end, and it has a flange extending outwardly from the body of the base member. More specifically, the flange is distal the tapered probe. Structurally, the reference unit includes a key that extends from the tool in a distal direction. Importantly, the fixed reference line on the dial has an integrally fixed relationship with this key. On the other hand, as noted above, the indicator rotates on the dial together with the base member of the drive assembly. Consequently, when the indicator has been rotated through an angle “θ”, the flange will be positioned relative to the key, at the same angle “θ”.

The engagement member of the tool is intended to simultaneously engage with the adjustment component (pinion or lead screw) on the adjustment mechanism, and with the drive assembly of the tool. Structurally, the engagement member is elongated and, preferably has a hex-head formed at its distal end. Its proximal end, on the other hand, is flared to establish a tapered cone. The engagement member also has a stem that extends axially in a proximal direction. As envisioned for the present invention, the stem is connected to the base member of the drive assembly in a manner that will allow the engagement member to freely rotate about the axis. It is also envisioned this connection will allow the engagement member to move axially through a limited distance, relative to the base member. Further, a spring is positioned on the stem to bias the engagement member and its hex-head in a distal direction from the base member.

In the operation of the present invention, the key on the tool (i.e. reference assembly) is engaged with a keyway on the repositioning mechanism to establish the stationary datum. At the same time, the hex-head of the engagement member is engaged with the pinion (lead screw). During these engagements, the tool is in a first configuration wherein the engagement member and the drive assembly are disconnected. Next, while the tool is still in its first configuration, the indicator is positioned at the predetermined angle “θ” from the reference line. Note: this also positions the drive member at the angle “θ” from the reference line. The base member is then advanced farther in a distal direction, against the spring bias. This advancement establishes a friction engagement between the tapered probe on the base member and the tapered cone of the engagement member. It also places the tool in its second configuration. Once this friction engagement has been established (i.e. the second configuration for the tool), the drive assembly and hex-head can be rotated through the angle “θ”. Consequently, the adjustment component moves the prosthetic tooth through a distance “d” (recall: rθ=d), or rotates the prosthetic tooth about its axis by the angle “θ”. Note: rotation of the drive assembly can be done either manually, or electronically (if an internal battery is provided).

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the system according to the present invention with portions shown in phantom for clarity;

FIG. 2A is a perspective view of the tool for the present invention positioned for engagement with a mechanism to move a work piece on the mechanism through a predetermined distance for purposes of the present invention;

FIG. 2B is a view of the tool shown in FIG. 2A when the tool is engaged with the mechanism for rotation of the tool through a predetermined angle;

FIG. 2C is a view of the tool shown in FIG. 2B after the tool has been rotated through the predetermined angle; and

FIG. 3 is a schematic view of an adjustment component for use with the present invention.

### DESCRIPTION OF THE PREFERRED EMBODIMENTS

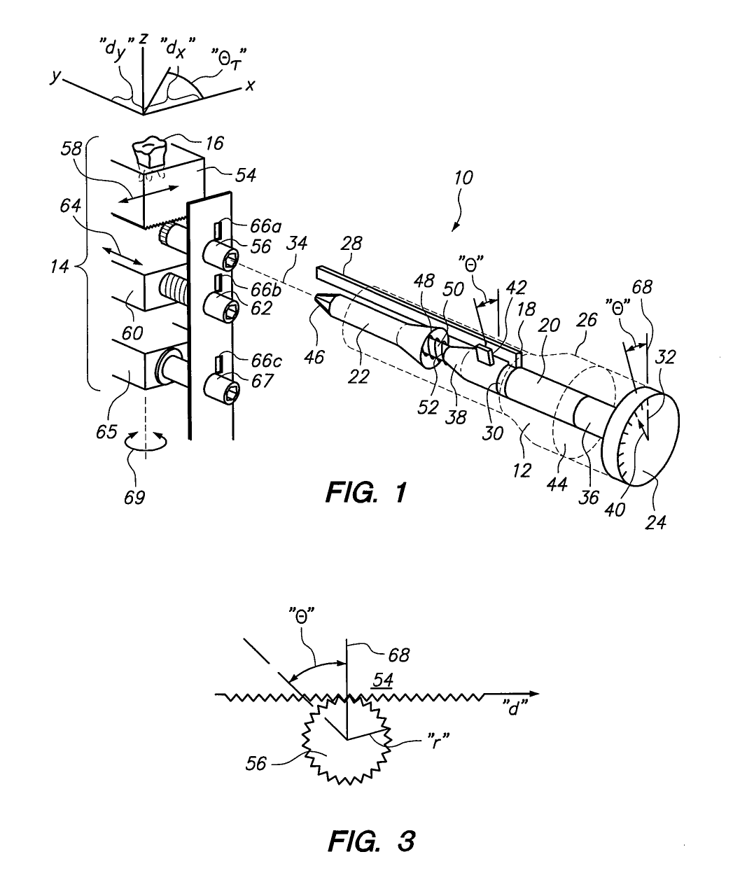

Referring initially to FIG. 1, a system for repositioning a work piece in accordance with the present invention is shown, and is generally designated 10. As shown, the system 10 includes a tool 12 and a mechanism 14. More specifically, the tool 12 is selectively engageable with the mechanism 14 to manipulate the mechanism 14 for movement of the work piece (e.g. a prosthetic tooth 16).

In detail, the tool 12 includes several essential subassemblies. These are: a reference unit 18, a drive assembly 20, an engagement member 22 and a dial 24. As shown in FIG. 1, these various subassemblies are housed together in a casing 26 (shown in phantom).

With specific attention to the reference unit 18 it will be seen in FIG. 1 that this subassembly includes a key 28. Importantly, the key 28 is affixed to a band 30 and, in turn, the band 30 is fixedly oriented relative to a reference line 32 on dial 24. Further, it is seen that the key 28 extends from the tool 12 in a distal direction, and it is oriented substantially parallel to an axis 34 that is defined by the tool 12. As intended for the present invention, the reference line 32 is an integral part of the reference unit 18 and is indicative of a stationary datum that is useable for monitoring and evaluating the operation of the tool 12.

In FIG. 1, the drive assembly 20 of tool 12 is shown to include an elongated base member 36 that defines the axis 34. This base member 36 is formed with a tapered probe 38 at its distal end, and it is integrally attached to an indicator 40 that is moveable on the dial 24 relative to the reference line 32. Accordingly, for purposes of the present invention, the drive assembly 20 (indicator 40) is able to rotate about the axis 34, relative to the reference unit 18 (reference line 32). Thus, an observation of the relative positions of indicator 40 and reference line 32 on the dial 24 gives a visual indication of the angular relationship between the drive assembly 20 and the reference unit 18. This angular relationship is indicated in the Figures by the angle “θ”. It will also be noted in FIG. 1, that the drive assembly 20 includes a flange 42. Specifically, the flange 42 is mounted to extend outwardly in a radial direction from the base member 36, and is located proximal the tapered probe 38. Additionally, the drive assembly 20 is shown to include a connector 44 that joins the casing 26 with the base member 36. Thus, the connector 44 can transfer a rotational force applied on the casing 26 to the base member 36 for rotation of the base member 36.

The engagement member 22 of tool 12 is shown, in FIG. 1, to be formed with a hex-head 46 at its distal end. As will be appreciated by the skilled artisan, however, the hex-head 46 is only exemplary, as various other engagement configurations could be used. In any event, the proximal end of the engagement member 22 is shown formed as a hollow tapered cone 48. Specifically, the tapered cone 48 is dimensioned to receive the tapered probe 38 of the drive assembly 20 in a mating engagement. Specifically, the intention of the present invention is that the tapered probe 38 of the drive assembly 20 can be joined with the tapered cone 48 of the engagement member 22 for joint rotation, together. For this purpose, a friction engagement is envisioned, and textured mating surfaces on the cone 48 and probe 38 may enhance such an engagement. Other structural components that will accomplish this same purpose are envisioned for the present invention.

Still referring to FIG. 1, the engagement member 22 is shown to have a stem 50 that extends along the axis 34 in a distal direction from the engagement member 22. For purposes of the present invention, this stem 50 orients the engagement member 22 with the drive assembly 20. When the engagement member 22 is not engaged with the drive assembly 20, however, the stem 50 also allows the engagement member 22 to rotate independently about the axis 34. Further, FIG. 1 also shows that a spring 52 is positioned on the stem 50 to bias the engagement member 22 in a distal direction from the drive assembly 20.

As shown in FIG. 1, the mechanism 14 includes an element 54 that engages with an adjustment component 56 for movement of the element 54 back and forth in an x-direction, as indicated by the arrows 58. Similarly, the mechanism 14 includes an element 60 that engages with an adjustment component 62 for movement of the element 60 back and forth in a y-direction, as indicated by the arrows 64. Also, the mechanism 14 includes an element 65 that engages with an adjustment component 67 for rotational movement of the element 65 about the z-axis (i.e., the axis of the tooth 16), as indicated by the arrows 69. While FIG. 1 illustrates that the element 65 rotates about the z-axis, the element 65 may be designed for rotation about the x-axis or y-axis, if desired. Further, the mechanism 14 is formed with a keyway 66a adjacent the adjustment component 56, a keyway 66b adjacent the adjustment component 62, and a keyway 66c adjacent the adjustment component 67. As envisioned for the system 10 of the present invention, the elements 54, 60 and 65 interconnect with each other in such a manner that causes the elements 54, 60, and 65 to move together in the y-direction, while the element 54 can be moved independently of the elements 60, 65 in the x-direction, and the element 65 can be rotated independently of the elements 54, 60. For this particular arrangement, the combination of element 54 and component 56 would preferably be a rack-and-pinion assembly of a type well known in the pertinent art (i.e. the rack is element 54, and the pinion is component 56). On the other hand, the combination of element 60 and component 62 would preferably be a lead screw assembly, also of a type well known in the pertinent art. Further, the combination of element 65 and component 67 would preferably be a rotation-translating joint, also of a type well known in the pertinent art.

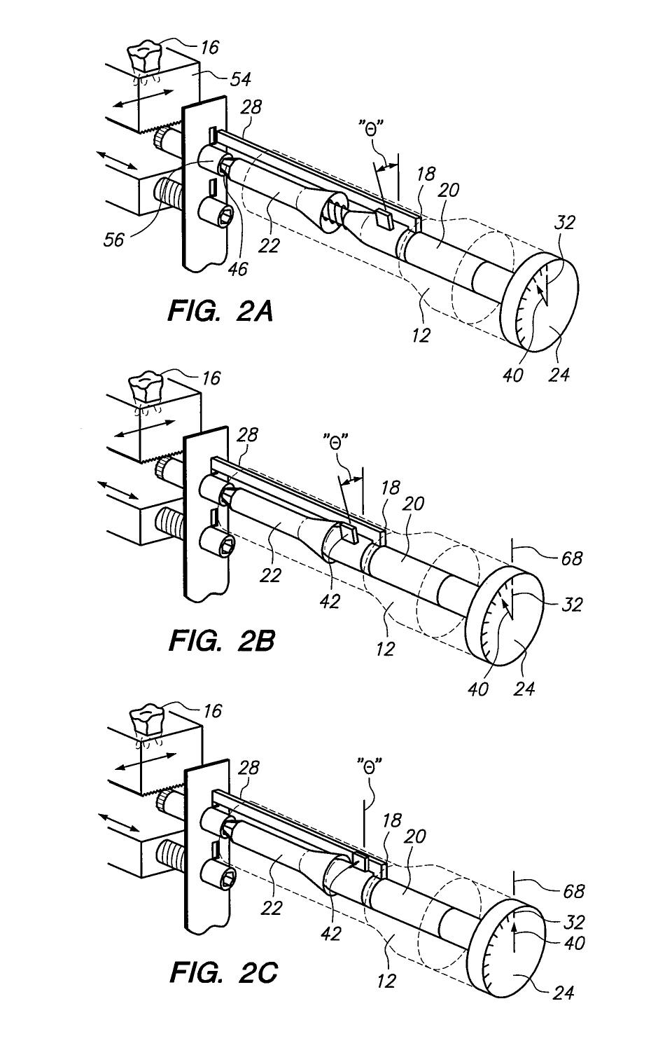

For the operation of the system 10, reference is collectively made to FIGS. 2A, 2B and 2C. For purposes of clarity in the illustration, element 65 and component 67 are not shown in the figures subsequent to FIG. 1. To begin, FIG. 2A shows an initial contact between the tool 12 and the mechanism 14. Specifically, this contact occurs when the hex-head 46 of the engagement member 22 is positioned in contact with the adjustment component 56. Also, at this point, the key 28 of reference unit 18 can be aligned with the keyway 66a on the mechanism 14. Further, the indicator 40 can be rotated to position the drive assembly 20 at a proper angle “θ”.

After contact has been established between the tool 12 and the adjustment component 56, the casing 26 is advanced in a distal direction toward the mechanism 14. This places the tool 12 in a first configuration (see FIG. 2B), and engages the tool 12 with the mechanism 14 for rotation of the adjustment component 56. More specifically, as shown in FIG. 2B, when the tool 12 is in its first configuration, the tapered probe 38 of the drive assembly 20 is engaged with the tapered cone 48 of the engagement member 22. Also, the key 28 of reference unit 18 is engaged with the keyway 66a. Importantly, with the engagement of key 28 with keyway 66a, a reference datum 68 is established for the tool 12. The tool 12 can then be rotated toward the reference datum 68, and through the angle “θ”, to change the tool 12 from its first configuration (see FIG. 2B) into a second configuration (see FIG. 2C).

In FIG. 2C, it will be seen that several aspects of the tool 12 have changed. For one, the flange 42 has been rotated through the angle “θ”. Specifically, with this rotation, the flange 42 is brought into contact with the key 28 (i.e. reference datum 68). Indeed, this contact ensures the tool 12 has rotated through the angle “θ”, and only through the angle “θ”. At the same time, the dial 24 gives a visual indication that the drive assembly 20 has rotated through the angle “θ”. The import of all this is, of course, that the adjustment component 56 has also been rotated by the engagement member 22 through the angle “θ”. The consequence of this will be best appreciated with reference to FIG. 3.

In FIG. 3, the element 54 and the adjustment component 56 are taken as being exemplary of a mechanical movement for the prosthetic tooth 16, as envisioned by the present invention. In this example, the element 54 is considered as being a rack, and the component 56 is considered as being a pinion, in a rack-and-pinion assembly. Then, if the pinion 56 has a radius “r” (as shown), and the angle “θ” is expressed in radians, the distance “d” that the element 54 will be moved by a rotation of the component 56 can be calculated from the expression d=rθ. A similar statement can be made for the consequence of rotating the component 62 through an angle “θ”. The overall result is that by using the tool 12 to selectively rotate the components 56, 62, and 67, the elements 54, 60, and 65 can be moved, linearly, in the directions of arrows 58 and 64. Further, rotation of the component 67 through an angle “θ” results in rotation of the element 65 through a substantially equal angle. The overall result is that by using the tool 12 to selectively rotate the components 56, 62, the elements 54, 60 can be moved, linearly, in the directions of arrows 58 and 64. Further, the tool 12 can be used to selectively rotate the component 67 to rotate the element 65 in the direction of arrows 69. This respectively achieves predetermined movements of the elements 54, 60 through linear distances dₓ and d_{y} and predetermined rotation of the element 65 through angle θ_{T}, wherein angle θ is substantially equal to angle θ_{T} (see FIG. 1).

While the particular Tool for Use With a Tooth Repositioning Mechanism as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for use in the manufacture of a dental appliance which comprises:
a mechanism for holding a prosthetic tooth;
an adjustment component mounted on the mechanism for rotation through a predetermined angle to reposition the prosthetic tooth on the mechanism;
a reference unit for engagement with the mechanism to establish a stationary datum for measuring the predetermined angle;
an elongated drive assembly defining an axis, the drive assembly being attached to the reference unit for movement relative to the datum during a rotation of the drive assembly about the axis; and
an engagement member mounted on the drive assembly for axial movement thereon between a first position wherein the engagement member is independently free to rotate about the axis, and a second position wherein the engagement member is engaged with the drive assembly for joint rotation therewith about the axis to rotate the adjustment component through the predetermined angle.

2. A system as recited in claim 1 wherein the reference unit, the drive assembly and the engagement member, in combination, define a tool.

3. A system as recited in claim 2 wherein the prosthetic tooth is moved by the tool from a start point through a predetermined linear distance “d”, and wherein the tool has a first engagement configuration when the work piece is at the start point, and the tool has a second engagement configuration when the work piece has moved through the distance “d”.

4. A system as recited in claim 3 wherein the mechanism is formed with a keyway adjacent the adjustment component, and the reference unit comprises:
a key extending substantially parallel to the axis of the drive assembly for engagement with the keyway; and
a dial with a reference line presented thereon, wherein the reference line is fixedly oriented relative to the key and is indicative of the stationary datum.

5. A system as recited in claim 4 wherein the drive assembly is formed with a tapered distal end and the engagement member is formed with a tapered cone at its proximal end for receiving the tapered distal end of the drive assembly therein, and further wherein the drive assembly comprises:
a flange extending radially outward from the drive assembly, with the flange located proximal to the tapered distal end; and
an indicator connected to a proximal end of the drive assembly and positioned on the dial for movement thereon relative to the reference line to identify an angular relationship between the drive assembly and the stationary datum.

6. A system as recited in claim 5 wherein the tool has a first engagement configuration when the prosthetic tooth is at the start point and it has a second engagement configuration after the work piece has been moved through the distance “d”, and further wherein a rotation of the tool through the predetermined angle changes the tool from its first configuration into its second configuration.

7. A system as recited in claim 6 wherein the adjustment component includes a rotation member having a radius “r”, and the adjustment component interconnects the tool with the prosthetic tooth for converting a rotation of the tool through an angle “θ” into a linear movement of the prosthetic tooth through the distance “d”, wherein the angle “θ” has a known dimensional relationship with the distance “d” (rθ=d).

8. A system as recited in claim 1 further comprising a pair of adjustment components respectively oriented on the mechanism to selectively move the prosthetic tooth in substantially orthogonal directions.

9. A system as recited in claim 2 wherein the prosthetic tooth is rotated by the tool from a start point through a predetermined angle “θ”, and wherein the tool has a first engagement configuration when the work piece is at the start point, and the tool has a second engagement configuration when the work piece has rotated through the angle “θ”.

10. A device for moving a work piece from a start point through a predetermined linear distance “d” which comprises:
a mechanism for holding the work piece;
a tool for engagement with the work piece, wherein the tool has a first engagement configuration when the work piece is at the start point, and the tool has a second engagement configuration after the work piece has been moved through the distance “d”;
a means for rotating the tool through an angle “θ” to change the tool from its first engagement configuration into its second engagement configuration; and
a mechanical means mounted on the mechanism to interconnect the tool with the work piece during the engagement for converting a rotation of the tool through the angle “θ” into a linear movement of the work piece through the distance “d”.

11. A device as recited in claim 10 wherein the tool comprises:
a reference unit for engagement with the mechanism to establish a stationary datum for measuring the predetermined angle “θ”;
an elongated drive assembly defining an axis, the drive assembly being attached to the reference unit for movement relative to the datum during a rotation of the drive assembly about the axis; and
an engagement member mounted on the drive assembly for axial movement thereon between a first position wherein the engagement member is independently free to rotate about the axis, and a second position wherein the engagement member is engaged with the drive assembly for joint rotation therewith about the axis to rotate the adjustment component through the predetermined angle “θ”.

12. A device as recited in claim 11 wherein the mechanical means includes a rotation member having a radius “r”, and the mechanical means establishes a known dimensional relationship with the distance “d” (rθ=d).

13. A device as recited in claim 12 further comprising a pair of mechanical means respectively oriented on the mechanism to selectively move the prosthetic tooth in substantially orthogonal directions.

14. A device as recited in claim 13 wherein one mechanical means is a rack and pinion, and the other mechanical means is a lead screw.

15. A device as recited in claim 11 wherein the rotating means is a casing connected to the drive assembly.

16. A method for positioning a prosthetic tooth for the manufacture of a dental appliance which comprises the steps of:
holding the prosthetic tooth on a mechanism;
mounting an adjustment component on the mechanism for rotation through a predetermined angle to reposition the prosthetic tooth on the mechanism;
engaging a reference unit with the mechanism to establish a stationary datum for measuring the predetermined angle;
attaching an elongated drive assembly defining an axis to the reference unit for movement relative to the datum during a rotation of the drive assembly about the axis; and
moving an engagement member mounted on the drive assembly between a first position wherein the engagement member is independently free to rotate about the axis, and a second position wherein the engagement member is engaged with the drive assembly for joint rotation therewith about the axis to rotate the adjustment component through the predetermined angle.

17. A method as recited in claim 16 wherein the reference unit, the drive assembly and the engagement member, in combination, define a tool, and wherein the prosthetic tooth is moved by the tool from a start point through a predetermined linear distance “d”, and wherein the tool has a first engagement configuration when the work piece is at the start point, and the tool has a second engagement configuration when the work piece has moved through the distance “d”.

18. A method as recited in claim 17 wherein the adjustment component includes a rotation member having a radius “r”, and the adjustment component interconnects the tool with the prosthetic tooth for converting a rotation of the tool through an angle “θ” into a linear movement of the prosthetic tooth through the distance “d”, wherein the angle “θ” has a known dimensional relationship with the distance “d” (rθ=d).

19. A method as recited in claim 16 further comprising a pair of adjustment components respectively oriented on the mechanism to selectively move the prosthetic tooth in substantially orthogonal directions.

20. A method as recited in claim 16 wherein the reference unit, the drive assembly and the engagement member, in combination, define a tool, and wherein the prosthetic tooth is rotated by the tool from a start point through a predetermined angle “θ”, and wherein the tool has a first engagement configuration when the work piece is at the start point, and the tool has a second engagement configuration when the work piece has rotated through the angle “θ”.
